(19) United States
(12) Patent Application Publication
(10) Pub. No.: US 2004/0220877 A1
(43) Pub. Date: Nov. 4, 2004

(54) Media center storage device proxy

(76) Inventor: Mark E. Albrecht, Hillsboro, OR (US)

Correspondence Address: BUCKLEY, MASCHOFF, TALWALKAR LLC, 5 ELM STREET, NEW CANAAN, CT, 06840, US

(21) Appl. No.: 10/428,286

(22) Filed: May 2, 2003

(51) Int. Cl. G06F 17/60

(52) U.S. Cl. 705/50

(57) ABSTRACT

According to some embodiments, a proxy is provided for a media center storage device.

### BACKGROUND

A media center may include a number of processors to store and/or provide audio and image information. For example, a media center might record and play music and movies. A media center may include a media subsystem, such as a processor adapted to retrieve and process a stream of image information from a high speed storage device (e.g., a hard disk drive). The media center may further include an application subsystem, such as a general purpose processor that performs other tasks. The application subsystem might, for example, provide a user interface and/or exchange information with one or more low speed storage devices, such as a Compact Disc (CD) drive and/or Digital Versatile Disc (DVD) drive.

### BRIEF DESCRIPTION OF THE DRAWINGS

FIG. 1 is a block diagram illustrating a media center.

FIG. 2 is a block diagram illustrating a media center according to some embodiments.

FIG. 3 is a block diagram illustrating the use of a proxy according to some embodiments.

FIG. 4 is a flow chart of a method associated with a media subsystem according to some embodiments.

FIG. 5 is a flow chart of a method associated with an application subsystem according to some embodiments.

FIG. 6 is a block diagram of a system according to some embodiments.

### DETAILED DESCRIPTION

Some embodiments described herein are associated with a “media center.” As used herein, the phrase media center may refer to, for example, a system that uses multiple processors to store and/or provide audio and/or image information. For example, the media center might process information (e.g., to play a movie) in accordance with the Motion Picture Experts Group (MPEG) 1 protocol as defined by International Organization for Standardization (ISO)/International Engineering Consortium (IEC) document number 11172-1 entitled “Information Technology—Coding of Moving Pictures and Associated Audio for Digital Storage Media” (1993).

Similarly, the media center might process information (e.g., to play music) in accordance with the MPEG1 audio layer 3 (MP3) standard and format for compression of audio information.

As still another example, the media center might retrieve information stored on a DVD and process the information in accordance with the MPEG2 protocol as defined by ISO/IEC document number 13818-1 entitled “Information Technology—Generic Coding of Moving Pictures and Associated Audio Information” (2000).

Other examples of information that might be processed include information in accordance with the MPEG4 protocol as defined by ISO/IEC document number 14496-1 entitled “Information Technology—Coding of Audio-Visual Objects” (2001), standard definition television signals, and High Definition Television (HDTV) signals.

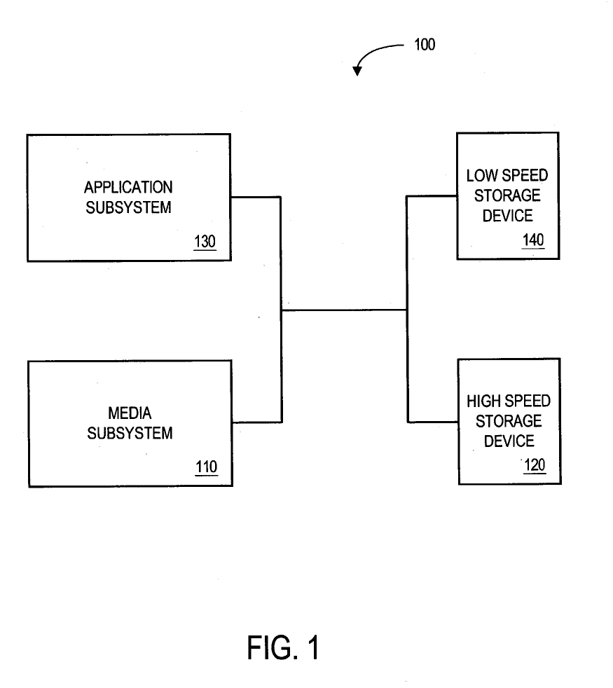

FIG. 1 is a block diagram illustrating a media center 100. The media center includes a media subsystem 110, such as a processor adapted to retrieve and process a stream of image information from a high speed storage device 120 (e.g., a hard disk drive). The media center may further include an application subsystem 130, such as a general purpose processor that performs other tasks. The application subsystem 130 might, for example, provide a user interface and/or exchange information with one or more low speed storage devices 140, such as a CD and/or DVD drive.

The media subsystem 110, high speed storage device 120, application subsystem 130, and low speed storage device 140 may exchange information via a shared interface. In this case, however, an exchange of information with the low speed storage device 140 could interrupt a stream of image information being sent from the high speed storage device 120 to the media subsystem 110. Such an interruption might degrade the performance of the media center 100 (e.g., by reducing the quality of a movie being played).

Media Center

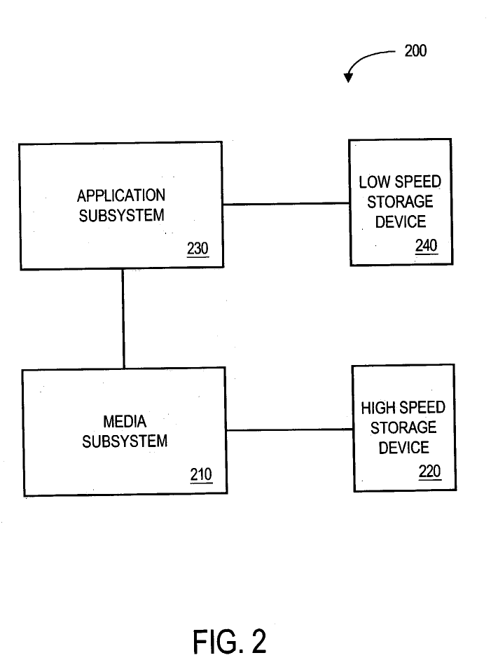

FIG. 2 is a block diagram illustrating a media center 200 according to some embodiments. The media center 200 includes a media subsystem 210 coupled to an application subsystem 230 via a first interface (e.g., a bus). The application subsystem 230 is coupled to a low speed storage device 240 via a second interface, and the media subsystem 210 is coupled to a high speed storage device 220 via a third interface.

The media subsystem 210 might comprise, for example, one or more processors that are designed and/or adapted to process an image information stream in substantially real time. The high speed storage device 220 may be any device that is able to transfer information to the media subsystem 210 at a relatively fast rate via the third interface (e.g., as compared to rate at the low speed storage device 240 can transfer information). For example, the high speed storage device 220 may be a hard disk drive that transmits a stream of high definition image information to the media subsystem 210 via a serial Advanced Technology Attachment (ATA) interface as described in the Serial ATA Working Group specification entitled “Serial ATA II: Extensions to Serial ATA 1.0” (October, 2002). The media subsystem 210 can then process the information as appropriate (e.g., to play a movie).

The application subsystem 230 may comprise, for example, one or more general purpose processors, such as an INTEL® PENTIUM® III processor. The application subsystem 230 may, for example, handle processing associated with a user interface (e.g., to let a user select and/or edit media information), an information coding or decoding process (e.g., associated with a CODEC), and/or a network application. The low speed storage device 240 may be any device that is able to transfer information to the application subsystem 230 at a relatively slow rate via the second interface (e.g., as compared to rate which the high speed storage device 220 can transfer information). For example, the low speed storage device 240 may be a CD or DVD drive that transmits a stream of information to the application subsystem 220 via an ATA interface. The application subsystem 230 can then process the information as appropriate (e.g., to play music).

Because information from the low speed storage device 240 is accessed via an interface other than the one used to access information from the high speed storage device 220, the performance of the media system 200 may be enhanced (e.g., a stream of information being transmitted from the high speed storage device 220 to the media subsystem 210 may not be interrupted when the low speed storage device 240 is accessed).

Storage Device Proxy

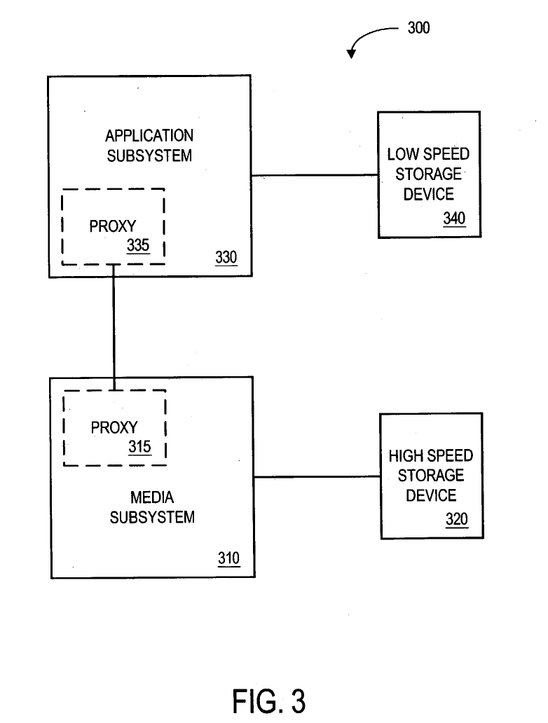

FIG. 3 is a block diagram illustrating the use of a proxy according to some embodiments. As in FIG. 2, a media center 300 includes a media subsystem 310 coupled to an application subsystem 330 via a first interface. The application subsystem 330 is coupled to a low speed storage device 340 via a second interface, and the media subsystem 310 is coupled to a high speed storage device 320 via a third interface.

According to this embodiment, a proxy 315 executes on the media subsystem 310. The proxy 315 may comprise, for example, a software program that transmits a request for data stored on the low speed storage device 340. In particular, when the media subsystem 310 needs to access data stored on the low speed storage device 340, the proxy 310 may transmit a request for that data to the application subsystem 330 via the first interface. The application subsystem 330 may retrieve the requested data from the low speed storage device 340 (e.g., via the second interface) and transmits the requested data to the media subsystem (e.g., by transmitting the requested data to the proxy 315 via the first interface).

By using the proxy 315 to perform these functions, the design of the media subsystem 310 may be simplified (e.g., the proxy 315 might mimic the operation of the actual device driver as far as other programs executing on the media subsystem 310 are concerned).

According to some embodiments, another proxy 335 executes on the application subsystem 330. This proxy 335 might, for example, receive the request from media subsystem proxy 315 and return the requested data to that proxy 315.

Methods

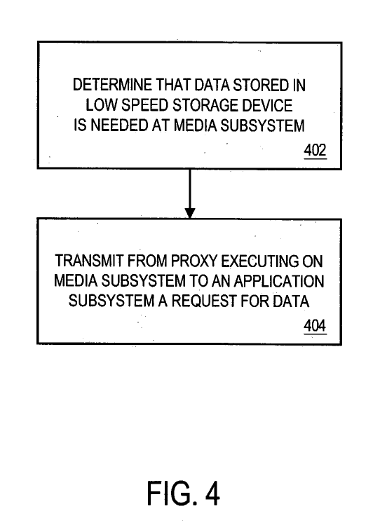

FIG. 4 is a flow chart of a method associated with the media subsystem 310 according to some embodiments. The flow charts described herein do not necessarily imply a fixed order to the actions, and embodiments may be performed in any order that is practicable. Note that any of the methods described herein may be performed by hardware, software (including microcode), or a combination of hardware and software. For example, a storage medium may store thereon instructions that when executed by a machine result in performance according to any of the embodiments described herein.

At 402, it is determined that data stored in the low speed storage device 340 is needed at the media subsystem 310. For example, a program executing on the media subsystem 310 might determine that it needs to access a file from a CD drive. The program might then attempt to access the file in the typical manner. The proxy 315, however, may detect that the program is attempting to access information from the low speed storage device 340.

At 404, a request for the data is transmitted from the proxy 315 to the application subsystem 330 (e.g., to the proxy 335 executing on the application subsystem 330) via the first interface.

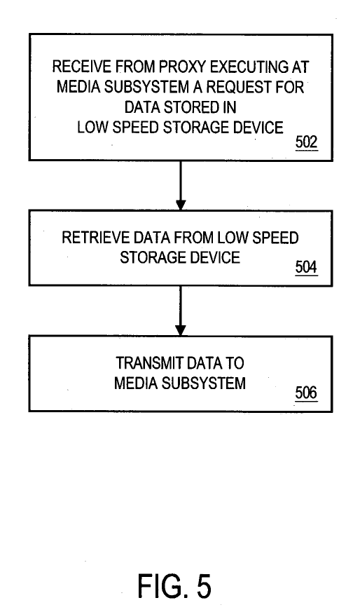

FIG. 5 is a flow chart of a method associated with the application subsystem 330 according to some embodiments. At 502, the request for data is received from the proxy 315 executing on the media subsystem 310. The requested data is retrieved from the low speed storage device 340 via the second interface at 504 (e.g., the file may be retrieved from the CD drive). At 504, the retrieved data is returned to the media subsystem 310. For example, the data may be transmitted to the proxy 315, which can in turn provide the data to the program that originally needed to access the data. Moreover, the program may receive the data in the same way as if the low speed storage device 340 was accessed in the usual manner.

System

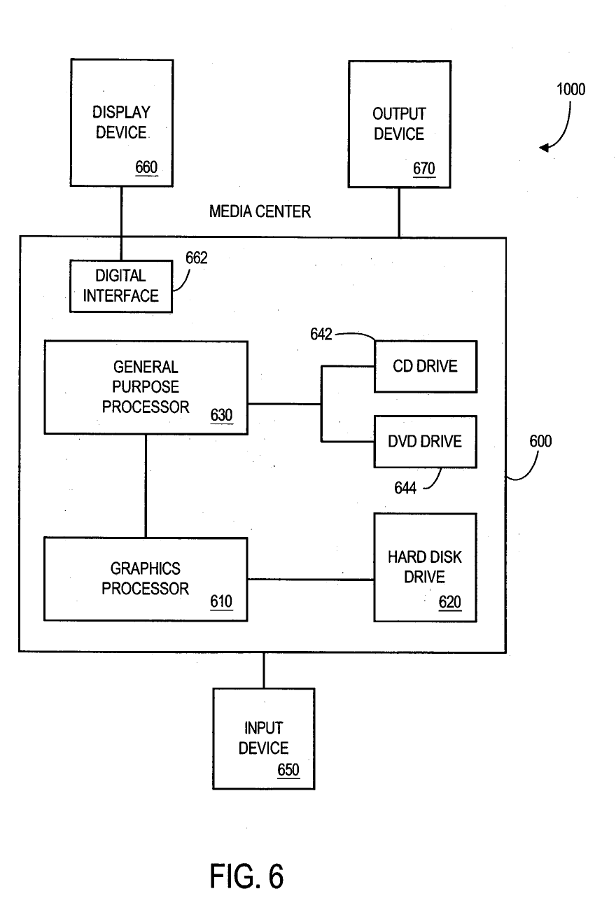

FIG. 6 is a block diagram of a system 1000 according to some embodiments. The system 1000 includes a media center 600 that may operate in accordance with any of the embodiments described herein. For example, the media center 600 may include a graphics processor 610 coupled to general purpose processor 630 via a first interface. The general purpose processor 630 may be coupled a CD drive 642 and a DVD drive 644 via a second interface, and the graphics processor 610 may be coupled to a hard disk drive 620 via a third interface. Moreover, the general purpose processor 630 may receive from a proxy executing on a the graphics processor 610 a request for data stored on the CD device 642 or the DVD drive 644.

The system 1000 further includes an input device 650 coupled to the media center 600. The input device 650 might be associated with, for example, a keyboard, a remote control, a game controller, a digital camera, and/or a communication port (e.g., adapted to exchange information via a network).

The system 1000 also includes a display device 660, such as a television or computer monitor. According to some embodiments, the system 1000 includes other output devices 670, such as a speaker or a printer. They media center 600 may also include a digital interface 662, such as a digital device interface adapted to provide digital display information (e.g., HDTV information). According to one embodiment, the media center 600 only provides analog display information.

Additional Embodiments

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

For example, although particular file formats and protocols have been described, embodiments may be used with any type of media information. Similarly, although particular configurations and implementations have been discussed, other arrangements may be provided (e.g., an application subsystem might have direct access to its own high speed storage device that is separate from the one accessed by the media subsystem).

The several embodiments described herein are solely for the purpose of illustration. Persons skilled in the art will recognize from this description other embodiments may be practiced with modifications and alterations limited only by the claims.

What is claimed is:

1. A method, comprising:
receiving via a first interface a request for data stored in a relatively low speed storage device, wherein the request is received from a proxy executing on a media subsystem; and
retrieving data from the low speed storage device via a second interface.

2. The method of claim 1, further comprising:
providing the retrieved data to the media subsystem.

3. The method of claim 2, wherein the retrieved data is provided via the first interface to the proxy executing on the media subsystem.

4. The method of claim 1, wherein the relatively low speed storage device comprises at least one of: (i) a compact disc drive, and (ii) a digital versatile disc drive.

5. The method of claim 1, wherein the media subsystem is adapted to exchange information with a relatively high speed storage device via a third interface.

6. The method of claim 1, wherein the relatively high speed storage device comprises a hard disk drive storing image information.

7. The method of claim 1, wherein said receiving is performed by a proxy executing on an application subsystem.

8. The method of claim 7, wherein (i) the media subsystem comprises a processor adapted to process an image information stream in substantially real time and (ii) the application subsystem comprises a general purpose processor.

9. The method of claim 7, wherein the application subsystem is associated with at least one of: (i) a user interface, (ii) an information coding process, (iii) an information decoding process, and (iv) a network application.

10. The method of claim 7, wherein the media subsystem and the application subsystem are associated with a media center.

11. An apparatus, comprising:
a storage medium having stored thereon instructions that when executed by a machine result in the following:
receiving via a first interface a request for data stored in a relatively low speed storage device, wherein the request is received from a proxy executing on a media subsystem, and
retrieving data from the low speed storage device via a second interface.

12. The apparatus of claim 11, wherein the instructions further result in:
providing the retrieved data to the media subsystem.

13. An apparatus, comprising:
a first interface to exchange information with a media subsystem;
a second interface to exchange information with a relatively low speed storage device; and
a general purpose processor adapted to (i) receive via the first interface a request for data stored in a relatively low speed storage device, wherein the request is received from a proxy executing on the media subsystem, and (ii) retrieve data from the low speed storage device via a second interface.

14. The apparatus of claim 13, wherein the general purpose processor is further adapted to provide the retrieved data to the media subsystem.

15. A method, comprising:
determining that data stored in a relatively low speed storage device is needed at a media subsystem; and
transmitting from a proxy executing on the media subsystem to an application subsystem a request for the data, wherein the request is transmitted via a first interface and the application subsystem is to retrieve the data from the low speed storage device via a second interface.

16. The method of claim 15, further comprising:
receiving the data from a proxy executing on the application subsystem.

17. An apparatus, comprising:
a storage medium having stored thereon instructions that when executed by a machine result in the following:
determining that data stored in a relatively low speed storage device is needed at a media subsystem, and
transmitting from a proxy executing on the media subsystem to an application subsystem a request for the data, wherein the request is transmitted via a first interface and the application subsystem is to retrieve the data from the low speed storage device via a second interface.

18. The apparatus of claim 17, wherein the instructions further result in:
receiving the data from a proxy executing on the application subsystem.

19. A system, comprising:
a media center, including:
an application subsystem,
a media subsystem coupled to the application subsystem via a first interface, and
a relatively low speed storage device coupled to the application subsystem via a second interface, wherein the application subsystem is to receive from a proxy executing on a the media subsystem a request for data stored on the low speed storage device; and
a digital device interface adapted to provide digital display information.

20. The system of claim 19, wherein the media center further includes:
a relatively high speed storage device coupled to the media subsystem via a third interface.
